(19) United States
(12) Patent Application Publication
(10) Pub. No.: US 2015/0092615 A1
(43) Pub. Date: Apr. 2, 2015

(54) TELECONFERENCE SYSTEM WITH OVERLAY AUFIO METHOD ASSOCIATE THERETO

(71) Applicant: David Paul Frankel, Los Gatos, CA (US)

(72) Inventor: David Paul Frankel, Los Gatos, CA (US)

(21) Appl. No.: 14/044,550

(22) Filed: Oct. 2, 2013

(51) Int. Cl. H04M 3/56; H04L 12/18

(52) U.S. Cl. CPC H04M 3/568; H04M 3/569; H04L 12/1822
USPC 370/260

(57) ABSTRACT

The present invention relates to a new method and system for use of a teleconference system, and more specifically a new method and system for using a teleconference system and multiple bridges where participants of a conference on a bridge can be segregated into two or more conference bridges and giving one bridge the ability to monitor and/or observe the primary conference in a first bridge as they participate in the secondary conference using a modular overlay. The overlay allows participants of the secondary conference to ‘observe’ the primary conference by means of sending to the secondary conference an attenuated version of the primary conference or a non-attenuated version capable of attenuation based on the participation level of the participants of the secondary conference. The current invention recreates the effect of using a one way mirror between two adjacent rooms to permit participants in the second room to monitor and keep track of the first room while being able to communicate in private.

### FIELD OF THE INVENTION

The present invention relates to a new teleconference system and associated method thereof, and more specifically a teleconference system with a multi-bridge where different categories of participants are segregated in the different bridges forming a primary conference and a secondary conference where the secondary conference participants benefit from an overlay to monitor and/or observe the primary conference.

### BACKGROUND

Part of human social and workplace dynamics include the need to gather and exchange information. In a live setting, information between participants is exchanged rather freely. Participants wishing to hold private conversations leave the main exchange area to sequester themselves for a brief period before they return to the main conference.

Workplace dynamics and social gatherings were once mostly conducted in the context of face-to-face interactions, forcing new individuals, clients, sales teams to travel to external venues to exchange information and hold costly meetings. Workplaces and employers with more than a single location were forced to spend considerable efforts to manage the flow of information between their different branches.

With the development and growth of low-cost remote technology (phone, Internet, etc.), cheap and cost efficient distance interaction between individuals has been facilitated but such exchanges remain somewhat limited due to the technology. This growth is such that the concept of a geographically fixed workplace is now being challenged as remote work spreads in the nation and around the world. Some employees prefer living in low-cost locations away from the principal place of business of a corporation. Commuting nightmares can also be limited thanks to teleconferencing. Finally, as international trade develops and foreign distributorships multiply, corporations are faced with the need to rely on flexible and efficient teleconferencing methods and systems. For this reason and many more, teleconferencing is a rapidly growing industry and new developments are critical to the rapid changes in today's business world.

Many significant advancements in teleconference technology have been made by the originator of the present invention, including the technology described in U.S. Pat. No. 7,986,644 (“Frankel I”), U.S. Pat. No. 7,343,908 (“Frankel II”), U.S. Pat. No. 8,370,142 (“Frankel III”), and U.S. Pat. No. 8,175,244 (“Frankel IV”) and U.S. patent application Ser. No. 13/691,100 (“Frankel V”). The content of each of Frankel I, Frankel II, Frankel III, Frankel IV, and Frankel V is hereby incorporated fully by reference as part of this application.

Today, yet another novel and improved system and associated method of use of a system of teleconferencing that offers users improved functionality over existing electronic systems of teleconferencing and even improved functionality over classical face-to-face conferencing methods is discussed.

Most are familiar with widely diffused and used teleconferencing technology. Participants who have signed up with an online service provider or a telephone-based service provider are given access codes to call into a single conference bridge. One of the best known and arguably the preferred method of remote communication is the use of a system where multiple participants each access an individually owned communication device such as a phone to join a remote conference call where a single bridge (room) is set up to merge all of the callers into a primary conference. Attendees connect for example using a conventional voice line such as a phone line or a wireless line, or using a device with Internet capacities to access either a voice network or a data network. With increasing bandwidth, easy to access data processing tools, and multiple networks accessed by devices capable of serial transceiver capacities, conference calls can now offer more than an audio component, but now can include a video and/or data component. Within the scope of this disclosure, while for the sake of simplicity what is described may be primarily a telephone-based and remote server based-system, what is contemplated is the use of any exchange of information and data over any type of network and system.

Generally speaking, within the scope of this disclosure, the terms participants, users, observers, moderators, subjects or any other synonym relates to the different actors capable of accessing in any way the system as described. One of ordinary skill in the art will recognize that, while one term may be used, it generally relates to a concept of use and a role taken as part of a conference experience.

Participants to a teleconference today can either send or receive audio data, video data, or other data components associated with the audio and/or video such as for example files, secondary images, digital slides of presentations, streaming, diagrams, documents, and even movies.

Traditional conferencing systems rely on open communication channels between a device used by one or more participants to connect to remote server holding software and hardware to create a conference bridge where the data such as the audio is mixed. The current conference systems receive multiple inbound audio/video/data from some or all of the participants and can play back an audio/video/data feed over the same or a different line.

Conferencing systems also rely on a “mix-minus” inbound/outbound exchange of data. In the mix-minus protocol, when three participants (A, B, and C) connect to the system, the feed on the playback to any of the participants will include all of the mixed inbound feeds to the conference bridge minus the party's own voice to help with clarity the same way as, in a normal two-way communication system a caller only receives audio from the other party and does not receive a feedback of its own voice. For example, participant A joining the conference on a bridge will hear back the mixed voices of participants B and C, participant B will hear back the mixed voices of parties A and C only, and participant C will hear back the mixed voices of participants A and B. This process allows a participant not to be bothered with the feedback of his or her own voice.

Traditional conferencing systems also offer the ability to join a teleconference bridge as either a participant, an observer, or a moderator. Participants are actors linked in a multi-way communication where they can talk on the bridge and receive sound to interact with the other participants. Observers are actors using the system that only receive inbound sound from the bridge, generally the mixed sound of all participants of a given teleconference. Audio transmitted by an observer is blocked and not heard by other actors. There are different types of moderators; these are generally given some limited access to different levels of control of the teleconference, for example their arrival or exit from the conference can initiate or end the teleconference session, or the moderator can mute some participants.

A known feature of teleconference systems is the use of muting or other modes of information control by either a participant or by the moderator to help the conference and manage the flow of data. Muting can be done using hardware such as the use of a mute button/indicator on a participant's own phone, or muting can be done by the local software controller by the participant or the moderator by using dual-tone multi-frequency (DTMF) keypad digits or via a web interface.

A participant, an observer, or a moderator can push one or several DTMF buttons, enter a predetermined code, or perform another system-defined step to toggle muting on and off of one or multiple different participants. Tools on the participant side and the moderator side can offer visual indicator of the selected mute status; this is very useful since a participant using a teleconference bridge with the mix-minus system will not as described above hear his or her own voice, and muting by a participant will not have any audible effect on the incoming feed of data.

A moderator for example can block the audio of any given participant or group of participants from the conference call. This feature is used for example by a supervisor to manage speaking rights of supervised employees during a conference call. A supervisor can mute some or all the employees to prevent interruptions, undesired background noise, or even feedback. Known systems offer tools to help participants and supervisors to help keep track of when any participant is muted or not. The false impression by a participant or a supervisor that a line is muted when in fact it is not can be greatly prejudicial.

The arrival of computer-based conference systems and methods of use thereof, while unable to fully replace the multiple benefits of live gatherings, may offer some benefits that are rarely or never available to live gatherings to offset these inherent limitations of using a remote system. What is needed are new functions offered in the context of a teleconferencing system that enhance the overall experience of participation, for example to recreate virtually the benefits of a one-way mirror used during police interrogations where some observers can stand remotely and monitor closely a primary event while at the same time be able to hold a second conversation.

### SUMMARY

The present invention relates to a new method and system for use of a teleconference system, and more specifically a new method and system for using a teleconference system and multiple bridges where participants of a conference on a bridge can be segregated into two or more conference bridges and one bridge be given the ability to monitor and/or observe the primary conference in a first bridge as they participate in the secondary conference using a modular overlay. The overlay allows participants of the secondary conference to “observe” the primary conference by means of sending to the secondary conference an attenuated version of the primary conference or a nonattenuated version capable of attenuation based on the participation level of the participants of the secondary conference. The current invention recreates the effect of using a one-way mirror between two adjacent rooms to help participants in the second room monitor and keep track of the first room while being able to communicate in private.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is a figure of a conference system from the prior art.

FIG. 2 is an illustration of the hardware and software used as part of the conference system shown at FIGS. 3 and 4.

FIG. 3 is an illustration of the different constituents of the teleconference system with overlay audio and method of use thereof.

FIG. 4 is a diagram of the of possible different bridge selection options opened and contemplated under the current invention described at FIG. 3 according to an embodiment of the present disclosure.

FIG. 5 is an illustration of a method of setting up a multi-group conference bridge teleconference with overlay according to another embodiment of the present disclosure.

### DETAILED DESCRIPTION

For purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

The art of remote teleconferencing system relies on the use of multiple different “rooms” also described as “bridges” or “conferences” in this disclosure. Two or more bridges are described herein as the use of a primary and a secondary conference where one or more participants of a meeting can be segregated away from a primary conference into the secondary conference. In one example, five participants call into a primary conference (participants A, B, C, D, and E). As two individuals would walk away from the main room into an adjacent room to hold a private conversation, participants D and E of the primary conference may be moved, in a virtual sense, into a separate secondary conference room where their conversation can be isolated from participants A, B, and C, who remain in the primary conference room. The use of a primary and a secondary conference room allows D and E to consult with each other privately, before returning to the original conversation. The toggle by participants between these primary and secondary rooms can be difficult to handle, resulting in confusion and wrongful assumptions of privacy. Very often a moderator is used to control the creation of and presence in the different bridges and virtual conference rooms.

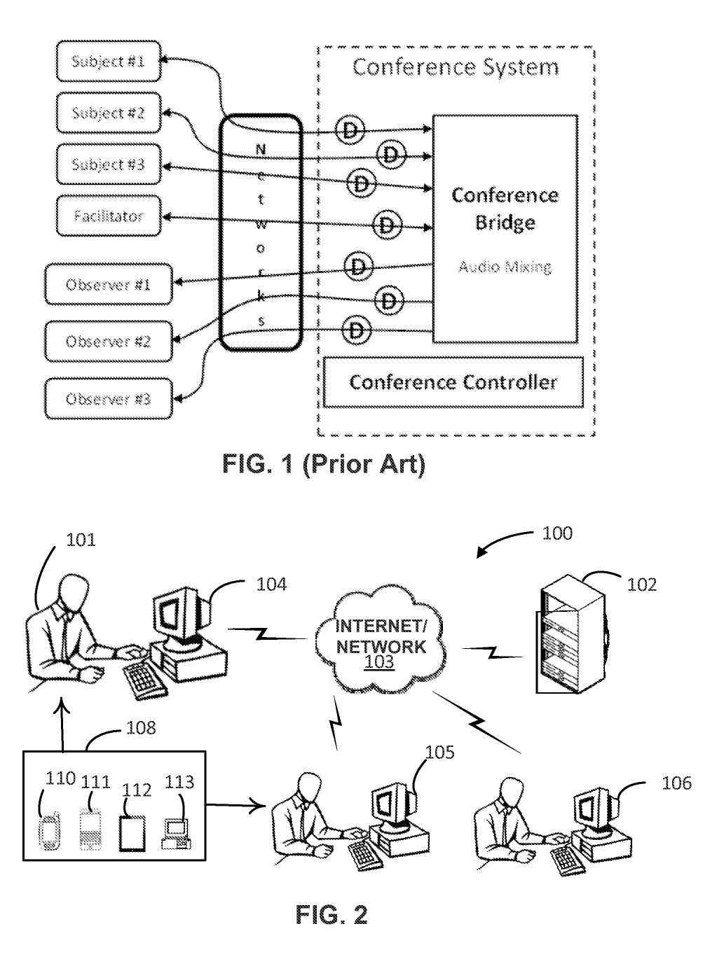

FIG. 1 shows existing conference systems known in the prior art. As described above, an example is shown of a conference system equipped with a conference controller to help manage different audio mixing over a conference bridge from a variable number of subjects (here #1, #2, and #3) also described herein as users and/or participants. These participants are connected to the single conference bridge by bi-directional links, as illustrated by a line with two arrows, enabling the participants to engage in multi-way communication.

As shown, a moderator and/or facilitator is connected to the conference bridge via a bi-directional link. Associated with each connection are detectors shown by the letter D in a circle capable of interfacing with the conference controller and the bridge to manage the flow of communication. The facilitator/moderator and three subjects/participants are connected using the bridge as an intermediary via bi-directional communications channels such as phone connections. Additionally, a variable number of observers (here #1, #2, and #3) are connected in a listen-only mode as illustrated by the one-way arrows to show the direction of the sound being sent to the observers from the bridge. In this configuration, the observers (#1, #2, and #3) cannot communicate with each other and cannot communicate with the facilitator or the subjects. The system is for example adapted to a corporate presentation to stockholders where stockholders can phone in as subjects and journalists phone in simply as observers. The network as shown may be the Public Switched Telephone Network or any other type of network.

The system as shown at FIGS. 1 and 2 includes a conference controller, which accepts input from the detectors and controls the behavior the conference bridge based on predetermined and programmed rules in the software interface. The conference bridge, detector(s) and conference controller are often implemented within a single system either as purpose-built hardware or as software running on standard hardware, or some combination of hardware and software as known in the industry. The connections to the participants may be in analog form, or digital using time-division multiplexing or packet transport or some other digital means.

FIG. 2 illustrates broadly one configuration of hardware associated with the teleconferencing system with overlay. As shown, the system 100 capable of executing and using software includes a plurality of remote users, for example users 101, 105, or 106. While three different persons are shown using the system 100, what is contemplated is the use of the system 100 by any number of individuals.

FIG. 2 shows the system 100 where a first user 101 that can be defined as a participant, a moderator, or an observer uses either a computer 104 or other device 108 such as a phone 110, a web-enabled phone 111, a pad 112, or any other type of computer device 113 to log into a server 102 where the conference system or a bridge can reside. The connection is done, for example, over a network 103 such as the Internet or any other network, like for example a local area network (LAN), the Public Switched Telephone Network, or a wireless network. A second user 105 is shown here using a computer but also able to be connected and using any one of a plurality of devices 108 and, as shown here, other users (subject, participant, facilitator, or observer) 106 will also be connected to the bridge on the server 102.

In one embodiment, the different actors 101, 105, and 106 can use a business telephone system (PBX) manufactured for example by Avaya®, connected via a Verizon® fixed-line telephone network. Other participants might use wireless phones, such Apple® iPhones® connected via the AT&T® mobile network, and Samsung Galaxy® phones connected over the Sprint® mobile network. These calls would be delivered as Internet protocol packets by the carriers to a conference server 102 or via digital time-division multiplexing signals or analog signals. While one configuration is shown, what is described is the use of any physical multiparty communication network and system.

Participants might use a telephony application such as Skype®, running on a Windows® computer, which could connect directly over the Internet to the same conference server 102. The conference server in one embodiment is a Dell® PowerEdge® server using Intel® x86 processor capacities. The server 102 accepts the packetized audio signals and performs the required functions at the direction of a program for that purpose.

In one embodiment, the server and the hardware or imbedded software is equipped with a plurality of detectors to analyze each audio packet stream, doing mathematical transformations on the data to detect dual-tone multi-frequency (DTMF) keypad digits, and to determine if the participant is or is not currently speaking DTMF is used for signaling over analog telephone lines in voice-frequency bands between different handsets and other communication devices and a switching center. The DTMF uses pushbutton tone dial recognition using the ITU-T standard. The use of DTMF is described for example in the International Telecommunication Union Standard F.902 issued in 1995, hereby incorporated fully herein by reference.

The data (audio/video/other) from the different participants is received and mixed according to the required mode of operation of the server and the software on the server as described hereinafter, and an appropriate audio packet stream is generated and sent back to each participant by the server 102 over the appropriate network 103. It is received at each participant's 101, 105, and 106 device 108 and often played through a speaker, a headset, or some display.

What is shown at FIG. 2 is one possible existing physical embodiment of the system 100 that includes multiple user devices, a server, and a network to connect the different elements to enable communication. One of ordinary skill in the art will understand that while FIG. 2 illustrates the hardware layer, embedded within the hardware are several software layers, used to execute different software tools and applications to help process the different data being transferred over the hardware system. Software layers include all layer 1 to layer 7 applications for the server 102, for the network 103 as enabled in hardware, and the different devices 108.

Computer program instructions may also be stored in a computer-readable memory that can direct a computer or other programmable data processing apparatus to function in a particular manner, such that the instructions stored in the computer-readable memory produce an output including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present methods and systems can be operational with numerous other general purpose or special purpose computing system environments or configurations. Examples of well-known computing systems, environments and/or configurations that can be suitable for use with the systems and methods include, but are not limited to, personal computers, server computers, laptop devices and multiprocessor systems. Additional examples include set-top boxes, programmable consumer electronics, network PCs, minicomputers, mainframe computers, distributed computing environments that comprise any of the above systems or devices, and the like. The systems and methods can be implemented in a public or private network and delivered as a cloud service.

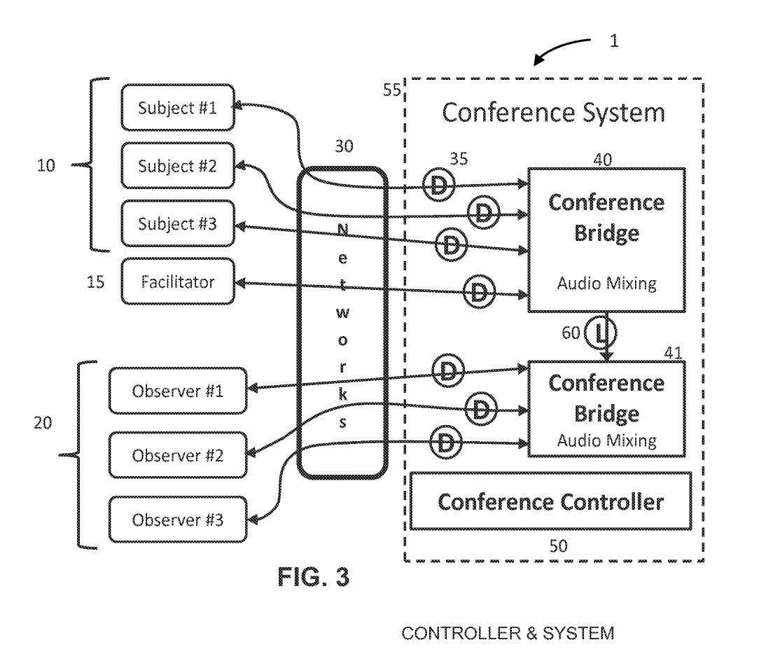

What is contemplated by this invention is a new system 1 with overlay L shown generally in one embodiment at FIG. 3. In this new configuration, two conference bridges 40, and 41 are created and managed by the conference controller 50, and described herein as a primary conference bridge 40 and a secondary conference bridge 41. Instead of having all of the subjects 10, the facilitator 15 and the observers 20 merged into a single conference bridge where the observers 20 were given only a one-way communication link to hear the conversation of the subjects and possibly the facilitator 15, the observers 20 are placed in their own secondary conference bridge 41 where they are given a bi-directional communication channel (shown by the double-sided arrows) to allow them to communicate with each other. The observers are thus transformed into a second subset of participants or subjects 10 given a special treatment by placing them into a single room (the same way observers of a police interrogation are placed in the back of a one-way glass window).

As shown in FIG. 3, the first of many very unique feature of this new system 1 is the creation of a link 60 between the primary conference bridge 40 and the secondary conference bridge 41 also called the overlay. The same way the detective behind a window made of one-way glass can watch the interrogation taking place in the primary room, the primary audio conference bridge mixed sound can in one embodiment be sent to the secondary conference bridge 60 to give the participants 20 of the second conference bridge 41 access to information of what is going on in the primary conference bridge 40. In a different embodiment, the role of each conference bridge can be reversed simply by reversing the flow of information 60 this time from the secondary conference bridge 41 to the primary conference bridge 40.

By way of an example of the different roles of the different users of the system 1 shown at FIG. 3, a common scenario involves a focus group made of multiple participants/subjects 10 where a facilitator/moderator 15 interviews these subjects 10 about their impressions of an existing or proposed product or service. Representatives of a sponsor of this activity who wish to observe the meeting 40 that is set up between the subjects 10 and the facilitator over a network 30 on the conference system 55 on a server, are thus given access to a secondary meeting room 41. In this configuration, the sponsor observers 20 can discuss openly their observations privately with each other while at the same time not disturbing the ongoing focus group discussion over the primary conference bridge 40. This is analogous to several detectives observing from a different room an interrogation between two detectives and a suspect in an adjacent room through a physical meeting via a one-way mirror. The sponsor representatives, here the observers 20 can be assigned to a secondary conference bridge 41.

As will be understood by one of ordinary skill, the secondary conference bridge or overlay can also be extended to include multiple secondary bridges or overlays and more complex arrangements for managing the audio among the multiple bridges. For example, the observers could be divided into subgroups, each using a separate secondary bridge or overlay. This could be done to allow each subgroup of observers to communicate privately amongst themselves while not being overheard by other subgroups of observers.

With regard to the overlays L 60 in FIG. 3, when an observer or participant of either groups 1, 2, or 3 in observer group 20 speaks, they are heard only by other observers of the conference bridge 41 to which they are connected and not by the primary focus group 10 currently using the primary conference bridge 40. A further refinement causes the audio or the overlay information L 60 of the primary focus group 10, as heard by the observer group 20, to be attenuated or changed when the audio level in the observer group 20 is not zero or some threshold level (i.e., some of the observers are speaking) The attenuation improves intelligibility and allows the observers 20 to be able to focus on their ongoing conversation instead while the background audio of the primary conference bridge 40 is lowered. When the observers 20 stop talking and the level in the secondary bridge 41 returns exclusively to the sound of the overlay L, then the primary focus group audio is restored to the normal or nonattenuated level.

The invention is applicable to other virtual meeting scenarios. For example, a corporation can use a conference call to deliver a report on its quarterly results to investors. The corporation executives and analysts are together in a primary group, while the investor relations specialist and a meeting moderator are in a “monitor” group and can listen to the meeting in progress while also discussing it. The moderator can move back to the primary group if he or she needs to address the primary participants.

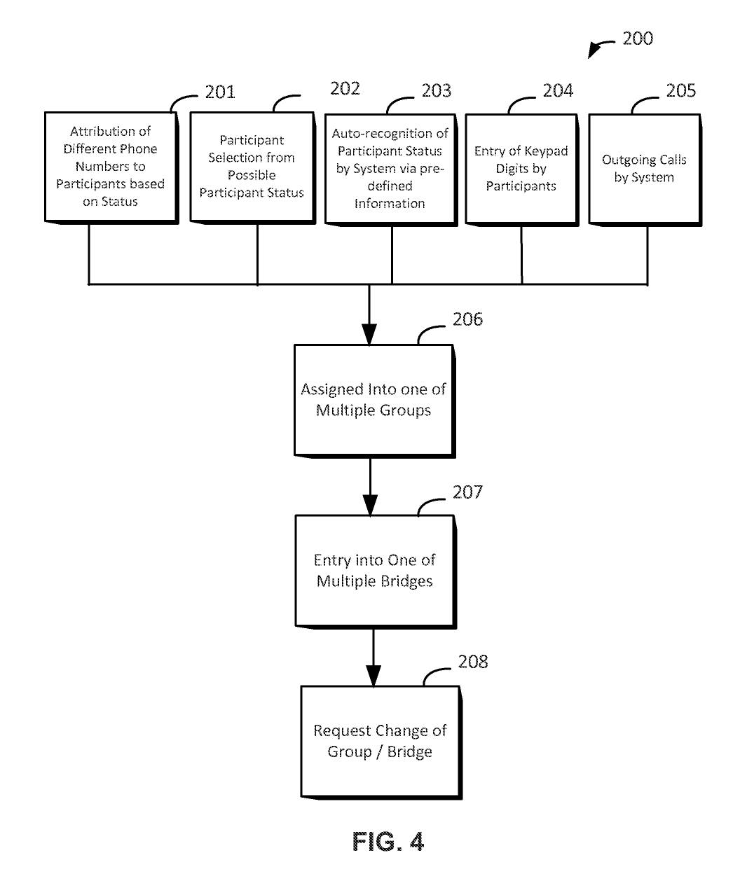

FIG. 4 shows the different steps 200 of a method of connection and routing of a participant as part of the system 1. In one embodiment, different phone numbers are assigned to those who want to join as a subject of a first group and of a different group. The participant can either be given only one of the contact numbers by the moderator 201 or any other means or the participant can select 202 what status it wants as part of the conference by selecting one of the numbers offered if more than one is offered.

In a third embodiment, upon connecting to the system 1, the participant can then be recognized 203 according to his calling line identification (CLI) or other source information which has been preprogrammed into the conference controller 50. In yet a fourth option, the participant can enter a series of keypad digits 204 which serve as an identifier preprogrammed into the conference controller 50 as indicating that the participant should connect to a specific group. In a fifth option, the conference controller 50 can place an outbound call 205 to connect the participant to the meeting in a specific group as designated by the organizer.

In all five cases 201, 202, 203, 204, or 205 the participant will be assigned initially to one of multiple specific group 206 and be placed in one of multiple bridges 207. Further, a participant of any one of multiple groups can change groups in one of multiple contemplated ways. The participant can enter a specific keypad code (for example, *23) or take any other action, including for example requesting from the moderator to change groups. When a participant is placed into a particular bridge, either initially or if subsequently moved, the system can play an announcement or give other feedback to the participant confirming their status. This can confirm to the participant that they will not be heard by the primary group, or can warn them that they will be heard.

Further, the system shown at FIG. 3 can be augmented in any number of ways, including adjusting the level of attenuation imposed by the overlay. The overlay level can range from no attenuation, so that the participants of the secondary conference bridge always hear the primary conference bridge, to a full attenuation that makes the overlay appear silent allowing the members of the secondary conference bridge to discuss without any interference from the primary conference bridge. This setting could be fixed within the implementation or could vary according to input from one of the participants or from the moderator.

In yet another alternate embodiment, the overlay may be made to return to full volume (i.e., no attenuation) after a period of time after the members of the group in the secondary conference bridge stop speaking A moderator or a participant can for example regulate the delay associated with the full-level return.

As part of the different commands made available to a participant of a group or the moderator as part of the system 1 shown at FIG. 3, these individuals can be given the capacity to move participants between the different communication bridges via keypad input, Internet-based control, voice command, or some other means. Other commands can include the capacity to change from a single direction overlay (only from conference 40 to 41) to a bidirectional mode. This would allow the primary communication bridge participants to overhear an overlay of the communication from the secondary communication bridge.

In yet another embodiment, a web-based control panel can provide the different participants and moderator with a visual representation of who is connected to each of the different conference bridges. Different user-friendly interface modules can highlight communications of the participants using colors or other effects. Controls can be provided for manipulating the user interface or to program this interface with images and/or pictures.

The presently described invention allows the assignment of multiple conference bridges to different groups of participants in a single meeting forming multiple or single groups. Depending on the circumstances and the need of a client, this assignment can be made when a participant first joins the meeting, and can be controlled by a facilitator, by the participant himself, or by a “preassignment” made by the meeting organizer. In another embodiment, a service provider can offer preselected packages covering some of the above scenarios with the precise contact information and numbers to call to join either of the groups using the system 1. The interface with the network 30 is not illustrated only for simplicity of understanding of the interrelationship of the different groups and bridges as shown.

The system 1 also allows for a change of group assignment at any time during the meeting, again through a variety of means, including actions on the part of a participant, or by a meeting facilitator. These controls can be exercised via an Internet-based control panel, or by entering specific codes on a telephone keypad, or by voice commands, or other means.

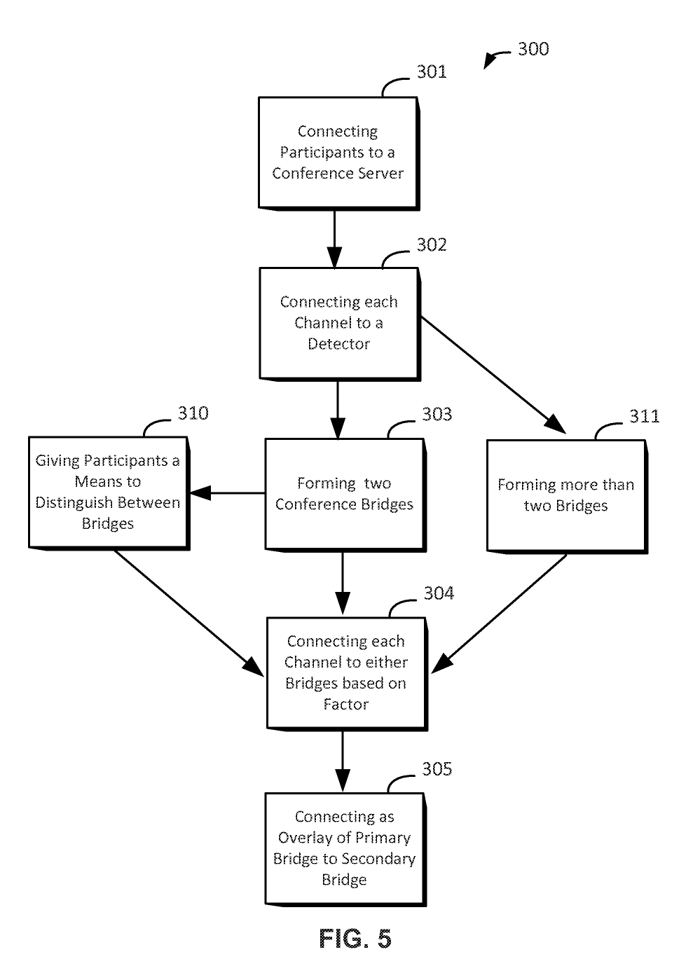

FIG. 5 illustrates generally the different steps associated with a method 300 to create a teleconferencing system for multiple groups of participants having an overlay. The method generally includes the step of connecting the device of participants to a conference server 301, then connecting each channel opened by the connection to a detector 302, then forming either two 303 or more 311 bridges, then connecting each channel to either of the bridges formed 304 either directly or via a means 310 given to the different participants to select the bridges, and finally using the system to generate an overlay of one bridge into the other 305.

What is contemplated is a teleconferencing system 1 for multiple participants, comprising a communication device 108 for each of a plurality of participants 101, 105, and 106 on FIG. 2, each communication device 108 connected via a network 103 on FIGS. 2 and 30 on FIG. 3 to a conference system 55 on a server 102. The conference system 1 including at least a conference controller 50 with a plurality of detectors 35 and at least a primary conference bridge 40 and a secondary conference bridge 41, where each communication device 108 of each of the plurality of participants 10, 15, and 20 on FIGS. 3 and 101, 105, and 106 on FIG. 2 is connected via a bi-directional communication channel via the network 30, and 103 to at least one of either the primary or secondary conference bridges 40, 41. At least one detector 35 from the plurality of detectors is assigned to one of the communication channels to control the communication channel via the conference controller 50, and where the conference controller 50 further mixes all of the communication channels illustrated by arrows connected to the primary conference bridge 40, and mixes all of the communication channels illustrated by arrows connected to the secondary conference bridge 41.

In another embodiment, the conference controller 50 of the conference system 55 further augments the secondary conference bridge 41 directing and mixing the mixed communication channels of the primary conference bridge 40 into the secondary conference bridge 41. The mixing of the mixed communication channels of the primary conference bridge can be attenuated. For example, the attenuation can be regulated based on the audio level of the mixed communication channels connected to the secondary conference bridge 41.

Also the bi-directional communication channels can be connected to more than two conference bridges. As shown at FIG. 4, there is also a means for each of the plurality of participants 10, 15, and 20 to distinguish a participation by each of the participants to either the primary or secondary conference bridges 40, 41. The selection of either the primary or secondary conference bridges 40, 41 is selected using one of the methods in a group consisting of: entry by a participant of DTMF information, a voice command, a calling line identification of the participant, a telephone number of the participant, and an internet destination of the dial-in by the participant.

Finally, what is also contemplated is as shown at FIG. 5 a method 300 of setting up a multi-group conference bridge teleconference with overlay, the method comprising of the steps of connecting 301 each of a plurality of participants via a bi-directional communication channel via a network each using a communication device via a network to a conference system on a server, connecting 302 each bi-directional communication channel to a detector controlled by a conference controller, forming 303 using the conference controller at least a primary conference bridge and a secondary conference bridge, and connecting 304 each of the bi-directional communication channels to either the primary conference bridge of the secondary conference bridge based on a pre-determined factor.

The method further includes for example the step of connecting via the conference controller of the conference system a mixed feed of all mixed communication channels in the primary conference bridge into the secondary conference bridge as an overlay 305. Also in a different embodiment, the step of forming bridges further includes the step of forming a tertiary conference bridge 311. Also the method further includes the step of attenuating the overlay level based on an audio level of the mixed communication channels connected to the secondary conference bridge and where the pre-determined factor 310 is a means given to each participants to distinguish between the primary and secondary conference bridges. wherein the means is in a group consisting of: entry by a participant of DTMF information, a voice command, a calling line identification of the participant, a telephone number of the participant, and an internet destination of the dial-in by the participant.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A teleconferencing system for multiple participants, comprising:
a communication device for each of a plurality of participants, each communication device connected via a network to a conference system on a server, the conference system including at least a conference controller with a plurality of detectors and capable of setting up and controlling at least a primary conference bridge and a secondary conference bridge,
wherein each communication device for each of the plurality of participants is connected via a bi-directional communication channel via the network to at least one of either the primary or secondary conference bridges,
wherein at least one detector from the plurality of detectors is assigned to one of the communication channels to notify the conference controller of events on the communication channel,
and wherein the conference controller further separately mixes all of the communication channels connected to the primary conference bridge, and mixes all of the communication channels connected to the secondary conference bridge.

2. The teleconference system of claim 1, wherein the conference controller of the conference system further mixes into the secondary conference bridge the mixed communication channels of the primary conference bridge.

3. The teleconference system of claim 2, wherein the mixed communication channels of the primary conference bridge are attenuated when mixed into the secondary conference bridge.

4. The teleconference system of claim 1, wherein the bi-directional communication channels are connected to more than two conference bridges.

5. The teleconference system of claim 2, further comprising a means for each of the plurality of participants to make a selection of connection to either the primary or secondary conference bridges.

6. The teleconference system of claim 3, wherein the attenuation is regulated based on the audio level of the mixed communication channels connected to the secondary conference bridge.

7. The teleconference system of claim 6, wherein the audio level is the presence of speech by any one of the participants in the secondary conference bridge.

8. The teleconference system of claim 5, wherein the selection is made using one of the methods in a group consisting of: entry by a participant of DTMF information, a voice command, a calling line identification of the participant, a telephone number dialed by the participant, and an internet destination of the dial-in by the participant.

9. The teleconference system of claim 5, wherein the selection is made by the conference system based on pre-programmed information.

10. A method of setting up a multi-group conference bridge teleconference with overlay, the method comprising of the steps of:
connecting each of a plurality of participants each using a communication device via a bi-directional communication channel over a network to a conference system on a server;
connecting each bi-directional communication channel to a detector controlled by a conference controller;
forming using the conference controller at least a primary conference bridge and a secondary conference bridge; and
connecting each of the bi-directional communication channels to either the primary conference bridge of the secondary conference bridge.

11. The method of claim 10, wherein the method further includes the step of connecting via the conference controller of the conference system a mixed feed of all mixed communication channels in the primary conference bridge into the secondary conference bridge as an overlay.

12. The method of claim 10, wherein the step of forming bridges further includes the step of forming a tertiary conference bridge.

13. The method of claim 11, wherein the method further includes the step of attenuating the overlay level based on an audio level of the mixed communication channels connected to the secondary conference bridge.

14. The method of claim 11, wherein a means is given to each participants to select between the primary and secondary conference bridges.

15. The method of claim 14, wherein the means is in a group consisting of: entry by a participant of DTMF information, a voice command, a calling line identification of the participant, a telephone number dialed by the participant, and an internet destination of the dial-in by the participant.
